(19) United States
(12) Patent Application Publication
(10) Pub. No.: US 2025/0053802 A1
(43) Pub. Date: Feb. 13, 2025

(54) INPUT DATA TRANSFORMATION FRAMEWORK FOR LOW-VOLTAGE MODEL

(71) Applicants: International Business Machines Corporation, Armonk, NY (US); National Tsing Hua University, Hsinchu (TW)

(72) Inventors: Pin-Yu Chen, White Plains, NY (US); Nandhini Chandramoorthy, Mount Kisco, NY (US); Karthik V. Swaminathan, Mount Kisco, NY (US); Pradip Bose, Yorktown Heights, NY (US); Hao-Lun Sun, Tainan City (TW); Lei Hsiung, Kaohsiung City (TW); Tsung-Yi Ho, Hsinchu (TW)

(21) Appl. No.: 18/448,208

(22) Filed: Aug. 11, 2023

(51) Int. Cl. G06N 3/08; G06N 5/04

(52) U.S. Cl. CPC G06N 3/08; G06N 5/04

(57) ABSTRACT

Aspects of the invention include techniques for improving the accuracy of access-limited neural network inference in low-voltage regimes. A non-limiting example method includes training a first machine learning model to perform input transformation for reducing low-voltage bit errors for a deep neural network operating in a low-voltage regime. The training includes inputting training data into the first machine learning model such that, in response, the first machine learning model produces transformed training data; inputting the transformed training data into a clean machine learning model and into perturbed machine learning models, the perturbed machine learning models being generated by applying random bit errors to the clean machine learning model; and optimizing the first machine learning model based on a comparison of output of the clean machine learning model and of the perturbed machine learning models compared to groundtruth labels for the training data.

### BACKGROUND

The present invention generally relates to machine learning, and more specifically, to computer systems, computer-implemented methods, and computer program products for improving the accuracy of access-limited neural network inference in low-voltage regimes.

Energy-efficient computing is a primary consideration for the deployment of Deep Neural Networks (DNNs), particularly on edge devices and on-chip artificial intelligence (AI) systems. Increasing energy efficiency and lowering the carbon footprint of DNN computation involves iterative efforts from both chip designers and algorithm developers. Processors with specialized hardware accelerators for AI computing are now ubiquitous, capable of providing orders-of-magnitude more performance and energy efficiency for AI computation. In addition to reduced precision/quantization and architectural optimizations, low voltage operation is a powerful knob that impacts power consumption. The effects of undervolting and low-voltage operation on accelerator memories that store weights and activations during computation is being actively investigated.

### SUMMARY

Embodiments of the present invention are directed to techniques for improving the accuracy of access-limited neural network inference in low-voltage regimes. A non-limiting example method includes training a first machine learning model to perform input transformation for reducing low-voltage bit errors for a deep neural network operating in a low-voltage regime. In some embodiments, the training includes inputting training data into the first machine learning model such that, in response, the first machine learning model produces transformed training data. The training can further include inputting the transformed training data into a clean machine learning model and into perturbed machine learning models, the perturbed machine learning models being generated by applying random bit errors to the clean machine learning model. The training can further include optimizing the first machine learning model based on a comparison of output of the clean machine learning model and of the perturbed machine learning models compared to groundtruth labels for the training data.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments;

FIG. 2 depicts a block diagram of an example relaxed access NeuralFuse architecture in accordance with one or more embodiments;

FIG. 3 depicts a block diagram of an example restricted access NeuralFuse architecture in accordance with one or more embodiments; and

FIG. 4 is a flowchart in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number correspond to the figure in which its element is first illustrated.

### DETAILED DESCRIPTION

According to an aspect of the invention, there is provided a method for improving the accuracy of access-limited neural network inference in low-voltage regimes. A non-limiting example method includes training a first machine learning model to perform input transformation for reducing low-voltage bit errors for a deep neural network operating in a low-voltage regime. The training includes inputting training data into the first machine learning model such that, in response, the first machine learning model produces transformed training data. The training includes inputting the transformed training data into a clean machine learning model and into perturbed machine learning models, the perturbed machine learning models being generated by applying random bit errors to the clean machine learning model. The training includes optimizing the first machine learning model based on a comparison of output of the clean machine learning model and of the perturbed machine learning models compared to groundtruth labels for the training data. Advantageously, leveraging the first machine learning model to perform input transformations in this manner increases the inference accuracy of the deployed DNN model in low-voltage scenarios without loss of normal voltage accuracy.

In some embodiments, optimizing the first machine learning model includes calculating respective losses for the clean machine learning model and for the perturbed machine learning models, calculating a gradient based on the calculated losses, and updating parameters of the first machine learning model based on the calculated gradient. This has the technical effect of generating optimal parameters for the first machine learning model that minimize losses across both normal-voltage and low-voltage regimes.

In some embodiments, the perturbed machine learning models consist of from five to ten perturbed machine learning models. Advantageously, using five to ten perturbed machine learning models ensures stable performance without large standard deviations.

In some embodiments, the first machine learning model includes an encoder-decoder structure. Advantageously, the encoder-decoder structure provides an efficient architecture for sequence-to-sequence tasks such as transfer learning.

In some embodiments, the first machine learning model is selected from a group consisting of a convolution-based model, a deconvolution-based model, and a U-Net-based model. Advantageously, convolution-based models are computationally efficient for tasks where spatial and feature information needs to be processed together efficiently. Advantageously, deconvolution-based models are capable of handling scenarios where upsampling and feature decoding are required, such as reconstructing high-resolution outputs from low-resolution inputs. Advantageously, U-Net-based models are capable of preserving spatial information in tasks such as image segmentation.

In some embodiments, the transformed training data lies within a valid range based on a type of the training data. This has the technical effect of ensuring that the transformed output will include a value between [−1, 1] for each dimension.

In some embodiments, the method includes adding the trained first machine learning model on an input side of a deployed deep neural network (DNN) model, inputting additional data into the trained first machine learning model such that the trained first machine learning model transforms the additional data, inputting the transformed additional data into the deployed deep neural network, and performing, via the deployed deep neural network, an inference based on the transformed additional data. Advantageously, performing an inference in this manner ensures high-quality inferences in both normal-voltage and low-voltage regimes.

In some embodiments, the clean machine learning model is the deployed DNN model. Advantageously, this allows the deployed DNN model to be leveraged via backpropagation to train the first machine learning model and to build the various perturbed models directly even if the deployed DNN model is partially opaque.

In some embodiments, the deployed DNN model comprises a restricted access model, the clean machine learning model is not the deployed DNN model, and the clean machine learning model comprises a surrogate model. Advantageously, the use of a surrogate model in this manner allows the first machine learning model to be trained via backpropagation (through the surrogate model) when backpropagation is not allowed or possible through the deployed DNN model.

In some embodiments, the first machine learning model comprises a DNN model having fewer layers than the deployed DNN model has. This has the technical effect of providing a model-efficient (computationally efficient) means of transforming inputs prior to the deployed DNN model to ensure accuracy in low-voltage regimes. In particular, a relatively small DNN minimizes new cost overheads (training, etc.) during deployment.

According to an aspect of the invention, there is provided a system for improving the accuracy of access-limited neural network inference in low-voltage regimes. A non-limiting example system includes a memory, computer readable instructions, and one or more processors for executing the computer readable instructions, the computer readable instructions controlling the one or more processors to perform operations. The operations include training a first machine learning model to perform input transformation for reducing low-voltage bit errors for a deep neural network operating in a low-voltage regime. The training includes inputting training data into the first machine learning model such that, in response, the first machine learning model produces transformed training data. The training includes inputting the transformed training data into a clean machine learning model and into perturbed machine learning models, the perturbed machine learning models being generated by applying random bit errors to the clean machine learning model. The training includes optimizing the first machine learning model based on a comparison of output of the clean machine learning model and of the perturbed machine learning models compared to groundtruth labels for the training data. Advantageously, leveraging the first machine learning model to perform input transformations in this manner increases the inference accuracy of the deployed DNN model in low-voltage scenarios without loss of normal voltage accuracy.

In some embodiments, optimizing the first machine learning model includes calculating respective losses for the clean machine learning model and for the perturbed machine learning models, calculating a gradient based on the calculated losses, and updating parameters of the first machine learning model based on the calculated gradient. This has the technical effect of generating optimal parameters for the first machine learning model that minimize losses across both normal-voltage and low-voltage regimes.

In some embodiments, the perturbed machine learning models consist of from five to ten perturbed machine learning models. Advantageously, using five to ten perturbed machine learning models ensures stable performance without large standard deviations.

In some embodiments, the first machine learning model includes an encoder-decoder structure. Advantageously, the encoder-decoder structure provides an efficient architecture for sequence-to-sequence tasks such as transfer learning.

In some embodiments, the first machine learning model is selected from a group consisting of a convolution-based model, a deconvolution-based model, and a U-Net-based model. Advantageously, convolution-based models are computationally efficient for tasks where spatial and feature information needs to be processed together efficiently. Advantageously, deconvolution-based models are capable of handling scenarios where upsampling and feature decoding are required, such as reconstructing high-resolution outputs from low-resolution inputs. Advantageously, U-Net-based models are capable of preserving spatial information in tasks such as image segmentation.

According to an aspect of the invention, there is provided a computer program product for improving the accuracy of access-limited neural network inference in low-voltage regimes. A non-limiting example computer program product includes a computer readable storage medium having program instructions embodied therewith, the program instructions executable by one or more processors to cause the one or more processors to perform operations. The operations include training a first machine learning model to perform input transformation for reducing low-voltage bit errors for a deep neural network operating in a low-voltage regime. The training includes inputting training data into the first machine learning model such that, in response, the first machine learning model produces transformed training data. The training includes inputting the transformed training data into a clean machine learning model and into perturbed machine learning models, the perturbed machine learning models being generated by applying random bit errors to the clean machine learning model. The training includes optimizing the first machine learning model based on a comparison of output of the clean machine learning model and of the perturbed machine learning models compared to groundtruth labels for the training data. Advantageously, leveraging the first machine learning model to perform input transformations in this manner increases the inference accuracy of the deployed DNN model in low-voltage scenarios without loss of normal voltage accuracy.

In some embodiments, optimizing the first machine learning model includes calculating respective losses for the clean machine learning model and for the perturbed machine learning models, calculating a gradient based on the calculated losses, and updating parameters of the first machine learning model based on the calculated gradient. This has the technical effect of generating optimal parameters for the first machine learning model that minimize losses across both normal-voltage and low-voltage regimes.

In some embodiments, the perturbed machine learning models consist of from five to ten perturbed machine learning models. Advantageously, using five to ten perturbed machine learning models ensures stable performance without large standard deviations.

In some embodiments, the first machine learning model includes an encoder-decoder structure. Advantageously, the encoder-decoder structure provides an efficient architecture for sequence-to-sequence tasks such as transfer learning.

In some embodiments, the first machine learning model is selected from a group consisting of a convolution-based model, a deconvolution-based model, and a U-Net-based model. Advantageously, convolution-based models are computationally efficient for tasks where spatial and feature information needs to be processed together efficiently. Advantageously, deconvolution-based models are capable of handling scenarios where upsampling and feature decoding are required, such as reconstructing high-resolution outputs from low-resolution inputs. Advantageously, U-Net-based models are capable of preserving spatial information in tasks such as image segmentation.

Deep Neural Networks (DNNs) are a type of artificial neural network with multiple hidden layers between the input and output layers. DNNs have shown remarkable capabilities in various fields, including computer vision, natural language processing, speech recognition, and more. DNNs are the backbone of many state-of-the-art machine learning models and have contributed to significant advancements in artificial intelligence, but can require a large amount of energy, both during training and at inference. Efforts are ongoing to develop more energy-efficient DNN architectures and optimization techniques to mitigate their energy costs while maintaining or even improving their capabilities. In particular, reducing the energy consumption of DNNs can be accomplished by decreasing the voltage supplied to the DNN accelerator. However, reducing the DNN accelerator voltage can lead to exponential increases in bit failures. Moreover, some DNN models are not configurable or updatable. It would be helpful to find a solution for helping a DNN model operating in a low-voltage environment even if the DNN is not configurable or updatable. It would be helpful to find a reduced-energy solution for helping a DNN model operating in a low-voltage environment.

This disclosure introduces new methods, computing systems, and computer program products for improving the accuracy of access-limited neural network inference in low-voltage regimes. A new, model-agnostic machine learning model (referred to herein as the “NeuralFuse” architecture) is provided that allows for mitigating bit errors caused by very low voltage operation through a trainable input transformation parameterized by a relatively small DNN. The NeuralFuse is also referred to herein as a first machine learning model. The NeuralFuse sits between the input data and the deployed DNN (i.e., the primary DNN against which the energy savings was desired), to enhance the robustness of the original input and to provide accurate inference. As used herein, a “relatively small DNN” means a DNN that is smaller than the respective primary DNN. The term “smaller” may refer to a number of the layers and/or dimensions within the layers being smaller for the NeuralFuse than for the deployed, primary DNN. For example in at least some embodiments, the DNN of the NeuralFuse has a first number of layers and the deployed DNN has a second number of layers that is larger than the first number of layers. Thus, in at least some embodiments the NeuralFuse, i.e., the first machine learning model, includes a DNN model having fewer layers than the deployed DNN model has.

Notably, NeuralFuse is natively compatible (accepts) to scenarios under access-limited neural networks (e.g., non-configurable hardware such as system-on-a-chip or remote access to cloud-based APIs) to protect the deployed models from making wrong predictions under low power. Specifically, the NeuralFuse architecture described herein can operate under two practical access-limited scenarios: (a) Relaxed Access, where the model details are unknown but backpropagation through the black-box models is possible, and (b) Restricted Access, where models are unknown, and backpropagation is disallowed. For relaxed-access scenarios, NeuralFuse can be trained via backpropagation using gradient-based methods. For restricted-access scenarios, NeuralFuse can be trained on a white-box surrogate model that can be transferred (at high transferability) to the restricted access models. Consequently, unlike prior attempts to mitigate the tradeoffs of low voltage DNNs, the NeuralFuse architecture leverages a learning-based method to address random bit errors for improving accuracy in low-voltage conditions in a manner that is compatible with a range of access-limited settings.

Mitigating bit errors caused by very low voltage operation through a trainable input transformation parameterized by a relatively small DNN (i.e., the NeuralFuse architecture) in accordance with one or more embodiments described herein offers various technical advantages over prior approaches to reduce DNN energy consumption. Notably, NeuralFuse is “model agnostic” because the architecture operates in a plug-and-play manner at the data input and does not require re-training the deployed DNN model. Moreover, NeuralFuse is a naturally flexible model that allows for fine-tuning of the accuracy-energy tradeoffs-one can train multiple such models at different bit error levels for dynamic switching. Some embodiments include receiving anticipated bit error levels for the deployed DNN model and training the NeuralFuse based on those anticipated bit error levels. As explained further below, random bit errors used to produce perturbed models for training the NeuralFuse are, in some embodiments, based on anticipated bit error levels. Thus, the random bit errors are selected to fall within a range of the maximum anticipated bit error levels. Other advantages are possible. For example, the input data transformed by NeuralFuse can improve the accuracy of perturbed models (those with bit errors), and can retain the accuracy of clean model (those without bit errors). Memory access energy has been shown to be reduced by up to 24% while simultaneously improving the accuracy in low-voltage regimes by up to 57%.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

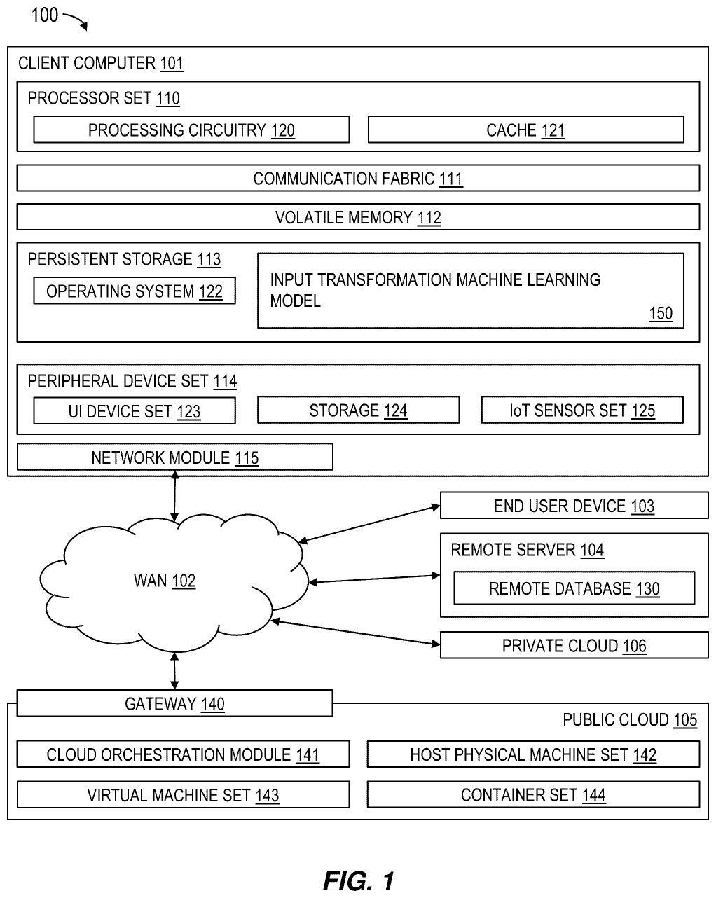

Referring now to FIG. 1, computing environment 100 contains an example of an environment for the execution of at least some of the computer code involved in performing the inventive methods, such as input transformation machine learning model 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

In some embodiments, a novel trainable input transformation machine learning model 150 that is a relatively small DNN (i.e., a NeuralFuse) can be leveraged with a larger DNN to mitigate the accuracy-energy trade-off for model inference and to overcome the drawback of performance degradation in low-voltage regimes. In some embodiments, a newly designed loss function and training scheme are used to derive the NeuralFuse for a given application and to apply the respective NeuralFuse to input data. The output from the NeuralFuse are themselves transformed inputs that are robust to low-voltage-induced bit errors. As used herein, “robust” to bit errors means that an inference (prediction) with bit errors maintains an accuracy within a predetermined threshold of a reference inference without bit errors. In some embodiments, for example, the performance delta (accuracy loss) between inferences made with vs. without bit errors (i.e., at low voltage vs. normal voltage) is less than 5%, or 3%, or 1%, although other performance deltas are within the contemplated scope of this disclosure. The transformed inputs (also referred to as robust representations) can then be fed to a base neural network model (e.g., a DNN) to make predictions that maintain accuracy at low voltages.

### Error-Resistant Input Transformation

Consider the input x sampled from the data distribution X and a model M_{P} with random bit errors on its weights (a so-called perturbed model). Observe that, when there are no bit errors (i.e., the normal-voltage settings), a perturbed model reduces to a nominal deterministic model denoted by M₀. In some embodiments, a NeuralFuse is built and inserted between the input data and the model M_{P} to ensure the perturbed model M_{P} can make correct inferences (using the transformed inputs) as well as retain consistent results of M₀ in regular (normal-voltage) settings. To adapt to different data characteristics, a NeuralFuse (F) can be designed to be input-aware, which can be formally defined according to Equation (1) as:

$$ℱ ( x ) = {clip}_{[ - 1 , 1 ]} ( x + 𝒢 ( x ) ) \qquad ( 1 )$$

where G(x) is a “generator” (i.e., an input transformation function within the input transformation machine learning model 150) that can generate a perturbation based on the input x. For some models such as relaxed access models, the M₀ and M_{P} are based on the final deployed model. For some models such as restricted access models, the M₀ and M_{P} are based on a surrogate model. The NeuralFuse transformed data F(x) (the robust representation) will be passed to another DNN model (M₀ or M_{P}) for inference. Without loss of generality, the transformed input can be assumed to be within a scaled input range F(⋅)∈[−1, 1]^{d}, where d is the (flattened) dimension of x. Thus, the transformed output is required to be between a normalization of from [−1, 1] for each dimension. The term d represents the number of input dimensions, e.g., pixels. This control of the range of the transformed data achieves that the transformed input remains within a range of validity for the type of the data. For example for training data that includes images, the transformed data remains within a standard range of the RGB values so that even after the transformation the transformed data still constitutes an image.

### Training Objective and Optimizer

To train the generator G(⋅), which should ensure the correctness of both the perturbed model M_{P} and the clean model M₀, we parameterize G(⋅) by a neural network and design a training objective function according to Equation (2):

$$arg {max}_{{𝒲}_{𝒢}} log {𝒫}_{M 0} ( y \vert ℱ ( x ; {𝒲}_{𝒢} ) ) + λ \cdot {E}_{{M}_{p} \sim {ℳ}_{p}} [ log {𝒫}_{{M}_{p}} ( y \vert ℱ ( x ; {𝒲}_{𝒢} ) ) ] \qquad ( 2 )$$

where W_{G} is the set of trainable parameters for G, y is the ground-truth label of x, P_{M} denotes the likelihood of y computed by a model M given a transformed input F(x; W_{G}), M_{P} is the distribution of the perturbed models inherited from the clean model M₀ under a p % random bit error rate, and X is a hyperparameter that balances the importance between the nominal and perturbed models. The training objective function can be readily converted to a loss function (loss) that evaluates the cross-entropy between the ground-truth label y and the prediction P_{M}(y|F(x; W_{G}). That is, the total loss function can be defined according to Equation (3):

$${Loss}_{Total} = {loss}_{{M}_{0}} + λ \cdot {loss}_{{ℳ}_{p}} \qquad ( 3 )$$

To optimize the loss function entailing the evaluation of the loss term loss_{M}_{_{P}} on randomly perturbed models, a new optimizer for solving (3) is defined, which can be referred to as the Expectation Over Perturbed Models (EOPM). EOPM-trained generators can generate error-resistant input transformations and mitigate the inherent bit errors. Such an approach is inspired by Expectation Over Transformation (EOT) attacks. EOT attacks aim to find a robust adversarial example against a variety of image transformations. Observe, however, that it can become computationally impossible or impractical to enumerate all possible perturbed models with random bit errors, and the number of realizations for perturbed models is limited by the memory constraint of the GPUs used for training. In practice, only N perturbed models are taken for each iteration to calculate the empirical average loss, defined according to Equation (4):

$${Loss}_{N} = \frac{{loss}_{{M}_{p 1}} + … + {loss}_{{M}_{{p}_{N}}}}{N} \qquad ( 4 )$$

where N is the number of simulated perturbed models {M_{P1}, . . . , M_{PN}} under random bit errors to calculate the loss. Therefore, the gradient used to update the generator can be calculated according to Equation (5) as follows:

$$\frac{\partial {Loss}_{Total}}{\partial {𝒲}_{𝒢}} = \frac{\partial {Loss}_{{M}_{0}}}{\partial {𝒲}_{𝒢}} + \frac{λ}{N} \cdot ( \frac{\partial {Loss}_{{M}_{p 1}}}{\partial {𝒲}_{𝒢}} + … + \frac{\partial {Loss}_{{M}_{{p}_{N}}}}{\partial {𝒲}_{𝒢}} ) \qquad ( 5 )$$

In some embodiments, N=10, although other values for N (3, 5, 7, 12, 20, 100, etc.) (e.g., the perturbed machine learning models consist of from five to ten perturbed machine learning models) are within the contemplated scope of this disclosure. Empirically, it has been found that a value of 10 can deliver stable performance, while there is little further gain (diminishing returns) in using a larger value. Conversely, smaller generators at relatively lower N values will have larger standard deviations because of the relatively weaker ability of representation learning.

### Training Algorithm

In some embodiments, the training steps for a NeuralFuse are defined according to Algorithm 1:

Algorithm 1 - Training Steps for NeuralFuse

Input: Base model M₀; Generator G; Training data samples X;
Distribution of the perturbed models M_{P}; Number of perturbed models
N; Total training iterations T
Output: Optimized parameters W_{G} for the Generator G

| | |
|---|---|
| 1: | for t = 0, ..., T − 1 do |
| 2: | for all mini-batches {x, y}^{B}_{b=1} ~ X do |
| 3: | Create transformed inputs xₜ = F(x) = clip_{[-1,1]} (x + G(x)) |
| 4: | Sample N perturbed models {M_{P1}, ..., M_{PN}} from M_{P} under p% |
| | random bit error rate. |
| 5: | for all M_{Pi} ~ {M_{P1} , ..., M_{PN}} do |
| 6: | Calculate the loss lossₚᵢ based on the output of the perturbed |
| | model M_{Pi}, then calculate the gradients gₚᵢ for W_{G} based on |
| | lossₚᵢ. |
| 7: | end for |
| 8: | Calculate the loss loss₀ based on the output of the clean model |
| | M₀, then calculate the gradients g₀ for W_{G} based on loss₀. |
| 9: | Calculate the final gradient g_{final} using Equation (5) based on g₀ |
| | and gₚ₁, ..., g_{pN}. |
| 10: | Update W_{G} using g_{final}. |
| 11: | end for |
| 12: | end for |

In some embodiments, the training data X is split into B mini-batches for training the generator in each epoch. For each mini-batch, these data are fed into F(⋅) to get the transformed inputs. N perturbed models are simulated using a p % random bit error rate, denoted by M_{P1}, . . . , M_{PN}, from M_{P}. Then, the transformed inputs are fed into these N perturbed models and the clean model M₀ to calculate their losses and gradients. Finally, NeuralFuse parameters W_{G} are updated based on the gradient obtained by EOPM (as discussed previously).

### NeuralFuse Generators

In some embodiments, the architecture of the NeuralFuse generator (G) is based on the Encoder-Decoder structure. Three subtypes of generators are provided, the so-called Convolution-based, Deconvolution-based, and U-Net-based generators, and each can consider both large (L) and small (S) network sizes. Both Convolution-based and Deconvolution-based variants will follow a similar architecture and a separate discussion is omitted. In some embodiments, the generators were trained with quantization-aware training. In some embodiments, convolution-based generators use Convolution with MaxPool layers for the encoder, and Convolution with UpSample layers for the decoder. In some embodiments, deconvolution-based generators use Convolution with MaxPool layers for the encoder, and Deconvolution layers for the decoder. In some embodiments, U-Net-based generators use Convolution with MaxPool layers for the encoder, and Deconvolution layers for the decoder. U-Net-based generators include a large number of feature channels in an upsampling part of the generator. The U-Net-based generators in at least some embodiments include a u-shaped architecture with a contracting path and an expansive path. Spatial information is reduced and feature information is increased in the contracting path.

### Relaxed and Restricted Access Settings

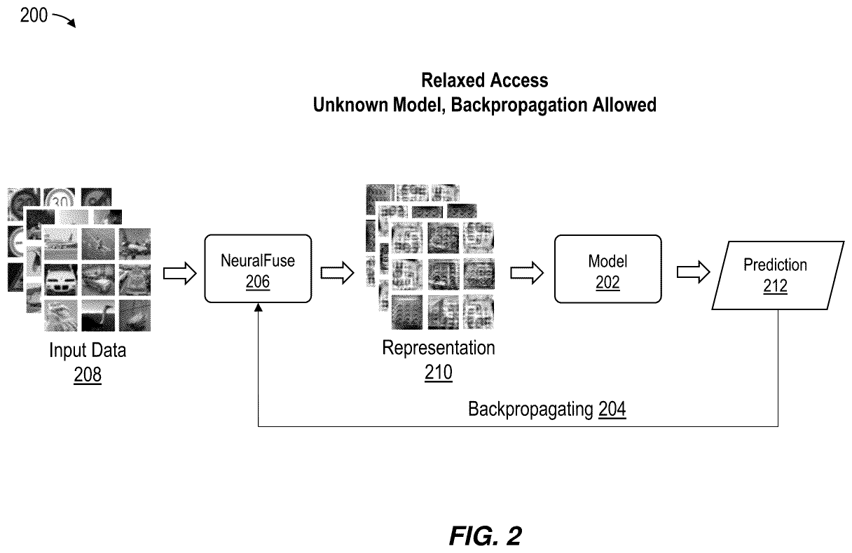

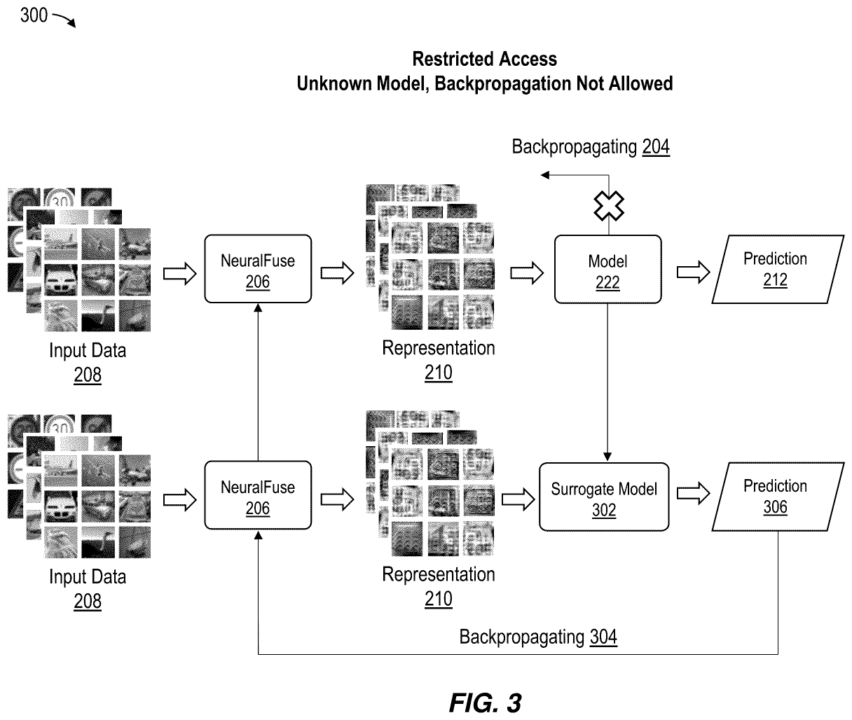

In some embodiments, the training, implementation, and/or integration of a NeuralFuse within an existing neural network architecture depends on the type of access to the base (primary) DNN model that is available. Two particular scenarios are described in detail: relaxed access (refer to FIG. 2) and restricted access (refer to FIG. 3).

FIG. 2 illustrates a block diagram of an example relaxed access NeuralFuse architecture 200 in accordance with one or more embodiments. In a relaxed access architecture, the details of a base model 202 (e.g., a deployed DNN) are unknown, but backpropagating 204 through the model 202 is possible. For example, while the internal information of the model 202 may not be entirely transparent, the model 202 allows obtaining gradients from the “black-box” through backpropagation. In this scenario, a NeuralFuse 206 can be trained directly by computing the gradients of the model 202. In some embodiments, the NeuralFuse 206 is directly trained with the model 202 using EOPM, as described previously.

As shown in FIG. 2, the trained NeuralFuse 206 receives input data 208 and outputs a robust representation 210 that is provided—in lieu of the raw input data 208—to the model 202. The robust representation 210 represents a transformation of the input data 208, which in the depicted example of FIG. 2 includes multiple images. FIG. 2 shows that the robust representation 210 are revised images compared to the images of the input data 208. The representation 210 (transformed inputs) can be generated as described previously (refer to Algorithm 1). The model 202 then generates, as output, a prediction 212. During training, groundtruth labels for the input data 208 are used in conjunction with the prediction 212 to optimize the NeuralFuse 206. The relaxed access model 202 is part of the training process. For inference that is performed via the NeuralFuse 206-model 202 combination after training of the NeuralFuse 206, the prediction 212 is advantageously robust to bit failures resulting from low voltage operation. This example arises in some instances when it is known that the model 202 is intended to be implemented in a low-voltage setting, so the NeuralFuse 206 is trained with this particular model 202 to prepare the NeuralFuse 206-model 202 combination to be effective in the low voltage setting. In this embodiment, the clean machine learning model that is part of the Algorithm 1 is the model 202, e.g., the deployed DNN model.

FIG. 3 illustrates a block diagram of an example restricted access NeuralFuse architecture 300 in accordance with one or more embodiments. In a restricted access architecture, the details of the base model 222 (e.g., a DNN) are unknown and backpropagating 204 through the model 222 is not possible (or not allowed, or otherwise not available). In this scenario, NeuralFuse 206 cannot be trained directly by computing the gradients of the model 222 (those gradients are not observable). Instead, a surrogate model 302 can be provided for gradient computation. Notably, the surrogate model 302 can be selected such that backpropagating 304 of predictions 306 is possible. Thus, the algorithm 1 is, for this embodiment, implemented with the surrogate model 302 instead of with the restricted access model 222. After training of the NeuralFuse 206 is completed without the model 222 (and using the surrogate model 302), in this embodiment, the NeuralFuse 206 is added on to the input side of the restricted access model 222 so that the NeuralFuse 206-model 222 combination performs inference effectively for one or more new samples of input data, even in a low voltage environment. For inference that is performed via the NeuralFuse 206-model 222 combination after training of the NeuralFuse 206, the prediction 212 is advantageously robust to bit failures resulting from low voltage operation.

Observe that, even in a restricted access architecture, the inference function itself will be available for the base model 222. In some embodiments, NeuralFuse 206 can be trained using the surrogate model 302 (a so-called white-box model) and the resultant generator (itself defined as described previously) can be transferred to the access-restricted model 222. In other words, once NeuralFuse 206 is trained on the surrogate model 302, the NeuralFuse 206 can be used to generate the representations 210 from input data 208 in a similar manner as described with respect to the relaxed access case. Thus, in this embodiment with the deployed DNN model comprising a restricted access model, the clean machine learning model is not the deployed DNN model, and the clean machine learning model comprises the surrogate model 302. The clean machine learning model that is part of the Algorithm 1 is the surrogate model 302 instead of the deployed DNN model 222.

A surrogate model for restricted access model embodiment is in at least some embodiments selected based on architecture and performance that is predicted for the restricted access model. Some surrogate models transfer well to different restricted access models. The selection in some embodiments includes performing trial and error to find a best surrogate model amongst a collection of available deep learning models through which backpropagation can be performed. In some embodiments, the restricted access model is used to validate results of tests performed with various surrogate models to train the NeuralFuse. Different NeuralFuses that result from the trial and error are added on to the restricted access model and test data is input into the various combinations. In some embodiments, without the restricted access model trial and error is performed using test data on various NeuralFuses that are produced and joined with various other models for test inferencing.

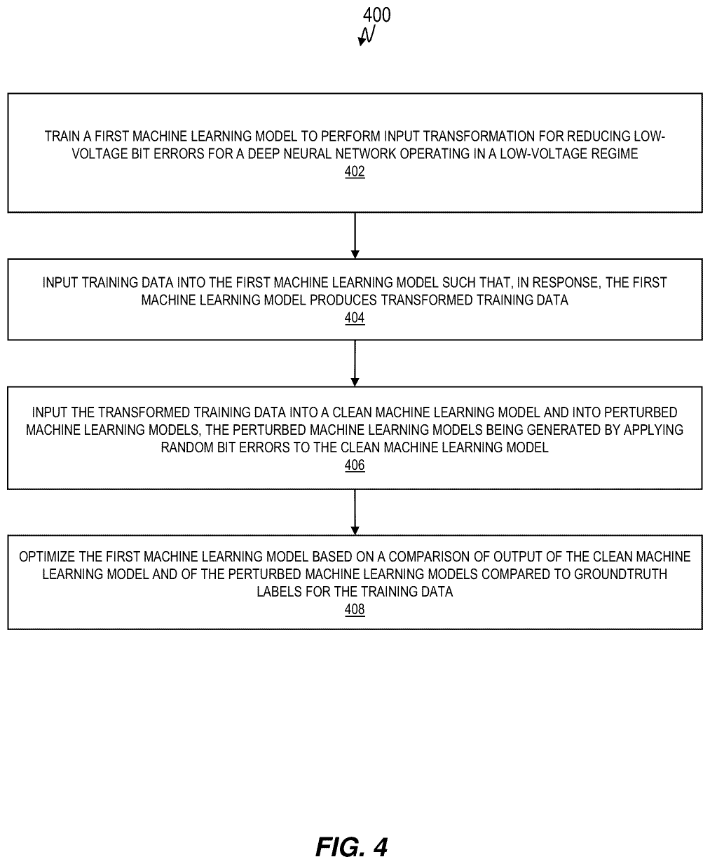

Referring now to FIG. 4, a flowchart of a method 400 for improving the accuracy of access-limited neural network inference in low-voltage regimes is generally shown according to an embodiment. The method 400 is described in reference to FIGS. 1-3 and may include additional blocks not depicted in FIG. 4. Although depicted in a particular order, the blocks depicted in FIG. 4 can be rearranged, subdivided, and/or combined. In exemplary embodiments, the method 400 can be performed by a computing environment (e.g., computing environment 100 shown in FIG. 1).

At block 402, the method includes training a first machine learning model to perform input transformation for reducing low-voltage bit errors for a deep neural network operating in a low-voltage regime. In some embodiments, the training includes one or more steps (refer to blocks 404, 406, and 408).

At block 404, the method includes inputting training data into the first machine learning model such that, in response, the first machine learning model produces transformed training data (also referred to as a representation). In some embodiments, the transformed training data lies within a valid range based on a type of the training data.

At block 406, the method includes inputting the transformed training data into a clean machine learning model and into perturbed machine learning models, the perturbed machine learning models being generated by applying random bit errors to the clean machine learning model. In some embodiments, the perturbed machine learning models consist of from five to ten perturbed machine learning models.

At block 408, the method includes optimizing the first machine learning model based on a comparison of output of the clean machine learning model and of the perturbed machine learning models compared to groundtruth labels for the training data.

In some embodiments, optimizing the first machine learning model includes calculating respective losses for the clean machine learning model and for the perturbed machine learning models, calculating a gradient based on the calculated losses, and updating parameters of the first machine learning model based on the calculated gradient.

In some embodiments, the first machine learning model includes an encoder-decoder structure. In some embodiments, the first machine learning model is selected from a group consisting of a convolution-based model, a deconvolution-based model, and a U-Net-based model.

In some embodiments, the method includes adding the trained first machine learning model on an input side of a deployed deep neural network (DNN) model, inputting additional data into the trained first machine learning model such that the trained first machine learning model transforms the additional data, inputting the transformed additional data into the deployed deep neural network, and performing, via the deployed deep neural network, an inference based on the transformed additional data.

In some embodiments, the clean machine learning model is the deployed DNN model.

In some embodiments, the deployed DNN model is a restricted access model, the clean machine learning model is not the deployed DNN model, and the clean machine learning model comprises a surrogate model.

In some embodiments, the first machine learning model is a DNN model having fewer layers than the deployed DNN model has.

In some embodiments, the input transformation module supports add-on capabilities such that the input transformation module can be inserted between the input data and the deployed DNN model without re-training the deployed DNN model.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
training a first machine learning model to perform input transformation for reducing low-voltage bit errors for a deep neural network operating in a low-voltage regime, wherein the training comprises:
inputting training data into the first machine learning model such that, in response, the first machine learning model produces transformed training data;
inputting the transformed training data into a clean machine learning model and into perturbed machine learning models, the perturbed machine learning models being generated by applying random bit errors to the clean machine learning model; and
optimizing the first machine learning model based on a comparison of output of the clean machine learning model and of the perturbed machine learning models compared to groundtruth labels for the training data.

2. The computer-implemented method of claim 1, wherein the optimizing the first machine learning model comprises:
calculating respective losses for the clean machine learning model and for the perturbed machine learning models;
calculating a gradient based on the calculated losses; and
updating parameters of the first machine learning model based on the calculated gradient.

3. The computer-implemented method of claim 1, wherein the perturbed machine learning models consist of from five to ten perturbed machine learning models.

4. The computer-implemented method of claim 1, wherein the first machine learning model comprises an encoder-decoder structure.

5. The computer-implemented method of claim 1, wherein the first machine learning model is selected from a group consisting of a convolution-based model, a deconvolution-based model, and a U-Net-based model.

6. The computer-implemented method of claim 1, wherein the transformed training data lies within a valid range based on a type of the training data.

7. The computer-implemented method of claim 1, further comprising:
adding the trained first machine learning model on an input side of a deployed deep neural network (DNN) model;
inputting additional data into the trained first machine learning model such that the trained first machine learning model transforms the additional data;
inputting the transformed additional data into the deployed deep neural network;
performing, via the deployed deep neural network, an inference based on the transformed additional data.

8. The computer-implemented method of claim 7, wherein the clean machine learning model is the deployed DNN model.

9. The computer-implemented method of claim 7, wherein the deployed DNN model comprises a restricted access model, the clean machine learning model is not the deployed DNN model, and the clean machine learning model comprises a surrogate model.

10. The computer-implemented method of claim 7, wherein the first machine learning model comprises a DNN model having fewer layers than the deployed DNN model has.

11. A system having a memory, computer readable instructions, and one or more processors for executing the computer readable instructions, the computer readable instructions controlling the one or more processors to perform operations comprising:
training a first machine learning model to perform input transformation for reducing low-voltage bit errors for a deep neural network operating in a low-voltage regime, wherein the training comprises:
inputting training data into the first machine learning model such that, in response, the first machine learning model produces transformed training data;
inputting the transformed training data into a clean machine learning model and into perturbed machine learning models, the perturbed machine learning models being generated by applying random bit errors to the clean machine learning model; and
optimizing the first machine learning model based on a comparison of output of the clean machine learning model and of the perturbed machine learning models compared to groundtruth labels for the training data.

12. The system of claim 11, wherein the optimizing the first machine learning model comprises:
calculating respective losses for the clean machine learning model and for the perturbed machine learning models;
calculating a gradient based on the calculated losses; and
updating parameters of the first machine learning model based on the calculated gradient.

13. The system of claim 11, wherein the perturbed machine learning models consist of from five to ten perturbed machine learning models.

14. The system of claim 11, wherein the first machine learning model comprises an encoder-decoder structure.

15. The system of claim 11, wherein the first machine learning model is selected from a group consisting of a convolution-based model, a deconvolution-based model, and a U-Net-based model.

16. A computer program product comprising a computer readable storage medium having program instructions embodied therewith, the program instructions executable by one or more processors to cause the one or more processors to perform operations comprising:
training a first machine learning model to perform input transformation for reducing low-voltage bit errors for a deep neural network operating in a low-voltage regime, wherein the training comprises:
inputting training data into the first machine learning model such that, in response, the first machine learning model produces transformed training data;
inputting the transformed training data into a clean machine learning model and into perturbed machine learning models, the perturbed machine learning models being generated by applying random bit errors to the clean machine learning model; and
optimizing the first machine learning model based on a comparison of output of the clean machine learning model and of the perturbed machine learning models compared to groundtruth labels for the training data.

17. The computer program product of claim 16, wherein the optimizing the first machine learning model comprises:
calculating respective losses for the clean machine learning model and for the perturbed machine learning models;
calculating a gradient based on the calculated losses; and
updating parameters of the first machine learning model based on the calculated gradient.

18. The computer program product of claim 16, wherein the perturbed machine learning models consist of from five to ten perturbed machine learning models.

19. The computer program product of claim 16, wherein the first machine learning model comprises an encoder-decoder structure.

20. The computer program product of claim 16, wherein the first machine learning model is selected from a group consisting of a convolution-based model, a deconvolution-based model, and a U-Net-based model.
